(19) United States
(12) Patent Application Publication
(10) Pub. No.: US 2021/0318066 A1
(43) Pub. Date: Oct. 14, 2021

(54) HEATING FURNACE

(71) Applicant: OLYMPUS CORPORATION, Tokyo (JP)

(72) Inventors: Shin TAKAGI, Kamiina-gun (JP); Masato NAKAHAMA, Tokyo (JP); Hironori HONJI, Tokyo (JP); Jun ICHINOSE, Tokyo (JP)

(73) Assignee: OLYMPUS CORPORATION, Tokyo (JP)

(21) Appl. No.: 17/340,321

(22) Filed: Jun. 7, 2021

Related U.S. Application Data
(63) Continuation of application No. PCT/JP2019/045890, filed on Nov. 22, 2019.

(30) Foreign Application Priority Data
Dec. 13, 2018 (JP) 2018-233819

(51) Int. Cl. F27B 5/14; F27B 5/02; F27B 5/13; F27B 5/16; F27B 5/18; F27B 5/04

(52) U.S. Cl. CPC F27B 5/14; F27B 5/02; F27B 5/13; F27M 2003/01; F27B 5/18; F27B 5/04; F27B 2005/161; F27B 5/16

(57) ABSTRACT

A heating furnace includes: a heating furnace main body that includes an accommodation chamber capable of accommodating a heating target object; a heat source capable of heating an inside of the accommodation chamber to an annealing point; a gas supply source that is arranged outside the heating furnace main body; and a pipeline that includes a pipeline main body that is arranged inside the accommodation chamber, and that is heated by the heat source, the pipeline main body being configured to retain a gas supplied from the gas supply source and heat the gas to the annealing point, and a discharge outlet that is formed on an end portion of the pipeline main body, and that is opened inside the accommodation chamber, the discharge outlet being configured to discharge the gas that is heated to the annealing point, to the inside of the accommodation chamber.

### CROSS-REFERENCE TO RELATED APPLICATION

This application is a continuation of PCT international application Ser. No. PCT/JP2019/045890, filed on Nov. 22, 2019 which designates the United States, incorporated herein by reference, and which claims the benefit of priority from Japanese Patent Applications No. 2018-233819, filed on Dec. 13, 2018, incorporated herein by reference.

### BACKGROUND

### 1. Technical Field

The present disclosure relates to a heating furnace.

### 2. Related Art

Japanese Laid-open Patent Publication No. 2005-49010 proposes a heating furnace of a hot air circulation system that is able to reduce a difference in atmosphere temperature between an upstream side and a downstream side by increasing a gas flow rate in the furnace and increasing an air flow speed.

### SUMMARY

In some embodiments, a heating furnace includes: a heating furnace main body that includes an accommodation chamber capable of accommodating a heating target object; a heat source capable of heating an inside of the accommodation chamber to an annealing point that is set to perform an annealing process on the heating target object; a gas supply source that is arranged outside the heating furnace main body; and a pipeline that includes a pipeline main body that is arranged inside the accommodation chamber, and that is heated by the heat source, the pipeline main body being configured to retain a gas supplied from the gas supply source and heat the gas to the annealing point, and a discharge outlet that is formed on an end portion of the pipeline main body, and that is opened inside the accommodation chamber, the discharge outlet being configured to discharge the gas that is heated to the annealing point, to the inside of the accommodation chamber.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram schematically illustrating a configuration of a heating furnace according to a first embodiment of the present disclosure;

FIG. 2 is a perspective view illustrating a configuration of a palette on which optical elements that are heating target objects are placed and a holding table in the heating furnace according to the first embodiment of the present disclosure;

FIG. 3 is a flowchart illustrating a flow of an annealing process using the heating furnace according to the first embodiment of the present disclosure;

FIG. 4 is a diagram schematically illustrating a configuration of a heating furnace according to a second embodiment of the present disclosure;

FIG. 5 is a graph representing a temperature distribution inside an accommodation chamber when a nitrogen gas at ordinary temperature is supplied to an inside of the accommodation chamber in a conventional heating furnace;

FIG. 6 is a graph representing a temperature distribution inside an accommodation chamber when a nitrogen gas that is heated by a pipeline is supplied to an inside of the accommodation chamber in the heating furnace according to the first embodiment of the present disclosure; and

FIG. 7 is a diagram schematically illustrating a configuration of a conventional heating furnace.

### DETAILED DESCRIPTION

Embodiments of a heating furnace according to the present disclosure will be described with reference to the drawings. The present disclosure is not limited to the embodiments below, and constituent elements in the embodiments described below include those that can easily be replaced by a person skilled in the art and those that are practically identical.

### First Embodiment

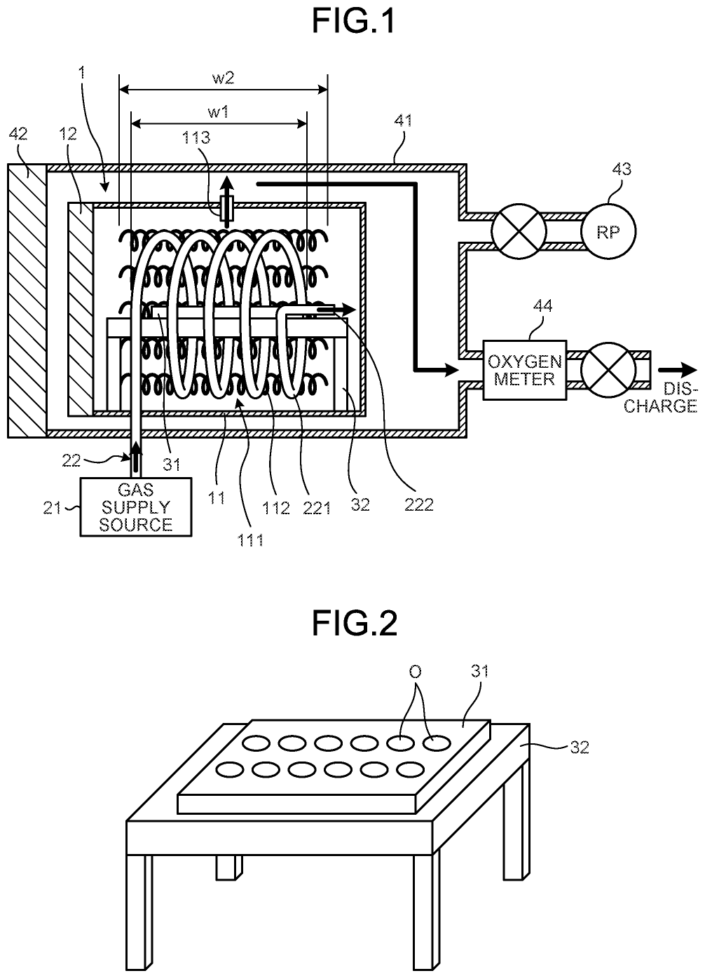

A heating furnace 1 according to a first embodiment of the present disclosure will be described below with reference to FIG. 1 to FIG. 3. The heating furnace 1 is used to perform an annealing process (heating process) on a press-molded optical element (e.g., lens). The heating furnace 1 is a heating furnace of an internal combustion system in which a heat source is arranged inside the furnace, and, as illustrated in FIG. 1, includes a heating furnace main body 11, a heat insulating cover 12, a gas supply source 21, and a pipeline 22.

The heating furnace main body 11 is configured such that at least inner wall surfaces are made of a thermal insulator material. Further, the heating furnace main body 11 is formed in a rectangular shape in which one side is opened. The heat insulating cover 12 is made of a thermal insulator material similarly to the heating furnace main body 11. The heat insulating cover 12 is arranged at the opened portion of the heating furnace main body 11 and seals the heating furnace main body 11.

An accommodation chamber 111 is a space for accommodating a heating target object and is formed in a rectangular shape. The accommodation chamber 111 is a space that is compartmented by the inner wall surfaces of the heating furnace main body 11 and an inner wall surface of the heat insulating cover 12, and all circumferences are covered with a thermal insulator material.

A heater (heat source) 112 for heating is arranged on the inner wall surfaces of the heating furnace main body 11. The heater 112 is for heating the inside of the accommodation chamber 111 to an annealing point that is set to perform annealing process on the heating target object. The heater 112 is arranged on each of opposing inner wall surfaces of the heating furnace main body 11. In FIG. 1, only the heater 112 that is arranged on one side (rear side) of the opposing inner wall surfaces of the heating furnace main body 11 is illustrated, but the heater 112 is also arranged on the inner wall surface on the other side (front side) (not illustrated). Meanwhile, an outlet 113 for discharging a gas inside the accommodation chamber 111 to the outside is arranged on a wall surface of the heating furnace main body 11.

The gas supply source 21 is arranged outside the heating furnace main body 11, and supplies a gas to the inside of the accommodation chamber 111 through the pipeline 22. Examples of the gas supplied by the gas supply source 21 include a nitrogen gas. The gas supply source 21 is connected to an end portion on one side of the pipeline 22.

The pipeline 22 is for introducing the gas supplied from the gas supply source 21 to the inside of the accommodation chamber 111 via a discharge outlet 222, and includes a pipeline main body 221 and the discharge outlet 222. The pipeline main body 221 is formed in a spiral manner, and is arranged inside the accommodation chamber 111. Further, the pipeline main body 221 is made of a metal material, such as stainless steel. The pipeline main body 221 may be configured with, for example, a spiral metal pipe with a linear distance of about 10 meters (m), a diameter of 20 centimeters (cm), an outer diameter of 6 millimeters (mm), and an inner diameter of 4 (mm).

The heating target object is arranged inside the spiral of the pipeline main body 221 at the time of the annealing process. As illustrated in FIG. 2, an optical element O as the heating target object is housed in each of a plurality of hole portions that are formed on a palette 31. Further, a holding table 32 on which the palette 31 is placed is arranged inside the spiral of the pipeline main body 221. Meanwhile, an upper surface of the holding table 32 is set at a height position such that, for example, “the palette 31 housed inside the accommodation chamber 111 is located at an intermediate height position of the accommodation chamber 111”. Meanwhile, the “intermediate height position of the accommodation chamber 111” indicates a height position at which a height of the accommodation chamber 111 is half the height of the accommodation chamber 111.

The pipeline main body 221 is heated by the heater 112 at the time of the annealing process. At this time, the pipeline main body 221 retains, in the pipeline 22, a gas that is at ordinary temperature and that is supplied from the gas supply source 21, and heats the gas to the annealing point.

The pipeline main body 221 is arranged in a region inside the accommodation chamber 111, the region facing the heater 112. In other words, as illustrated in FIG. 1, a width w1 of the spiral pipeline main body 221 is set to be equal to or smaller than a width w2 of the heater 112. In this manner, by setting the width w1 of the pipeline main body 221 to be equal to or smaller than the width w2 of the heater 112, it is possible to evenly heat the entire pipeline main body 221 at the time of the annealing process, so that it is possible to effectively heat the gas that flows inside the pipeline main body 221. For example, if the width w1 of the pipeline main body 221 is set to 20 cm, it is possible to set the width w2 of the heater 112 to about 24 cm that is larger than the width w1.

The discharge outlet 222 is arranged on an end portion on the other side of the pipeline main body 221. The discharge outlet 222 is opened inside the accommodation chamber 111. At the time of the annealing process, the pipeline main body 221 discharges the gas, which has been heated to the annealing point while flowing inside the pipeline main body 221, to the inside of the accommodation chamber 111 via the discharge outlet 222.

The discharge outlet 222 is opened at, in particular, the intermediate height position of the accommodation chamber 111. With this configuration, at the time of the annealing process, it is possible to discharge the heated gas from the intermediate height position of the accommodation chamber 111, so that it is possible to equalize the temperature inside the furnace (inside the accommodation chamber 111) at an early point, and it is possible to reduce variation in a temperature distribution inside the furnace.

Here, when the annealing process is performed by the heating furnace 1, as illustrated in FIG. 1, the heating furnace 1 is housed in a vacuum chamber 41 that is made of stainless steel, and a vacuum chamber door 42 seals the vacuum chamber 41. Then, a rotary pump 43 generates a vacuum state inside the vacuum chamber 41, and the gas supply source 21 supplies a nitrogen gas, so that the entire inside of the vacuum chamber 41 is in a non-oxidizing atmosphere.

Further, at the time of the annealing process, the nitrogen gas that is at ordinary temperature and that is supplied from the gas supply source 21 located outside passes through the spiral pipeline main body 221 and is discharged to the inside of the accommodation chamber 111 of the heating furnace 1 from the discharge outlet 222. At this time, the nitrogen gas that is supplied to the inside of the pipeline main body 221 is gradually heated while passing through the pipeline main body 221, so that the nitrogen gas is heated to temperature equal to the temperature (for example, the annealing point) inside the accommodation chamber when being discharged from the discharge outlet 222.

Meanwhile, at the time of replacement of the nitrogen gas, oxygen inside the accommodation chamber 111 is discharged to the inside of the vacuum chamber 41 through the outlet 113. Further, the vacuum chamber 41 includes an oxygen meter 44 that measures oxygen concentration inside the vacuum chamber 41 and a Piranie gauge (not illustrated) that measures a degree of vacuum inside the vacuum chamber 41.

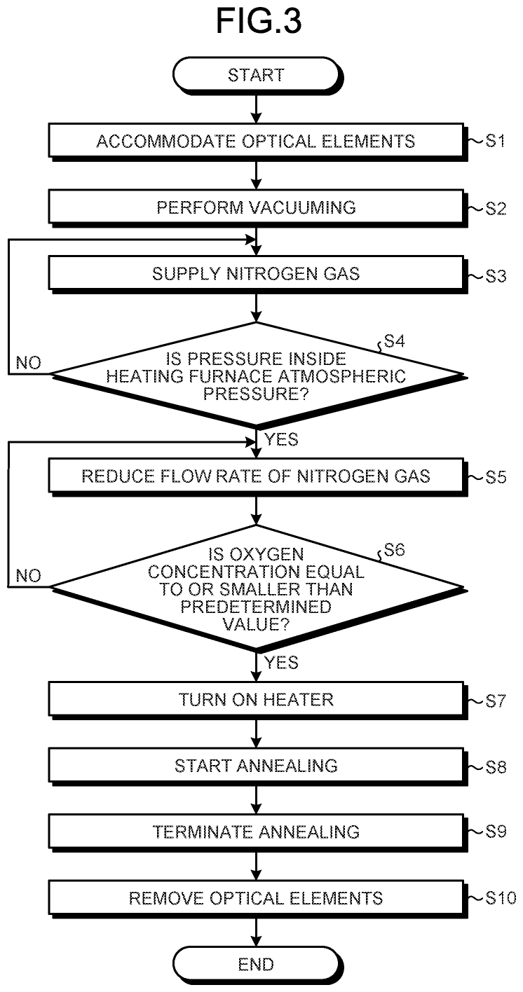

A flow of the annealing process using the heating furnace 1 according to the present embodiment will be described below with reference to FIG. 3. First, the plurality of optical elements O are housed in the palette 31, and the palette 31 is placed on the holding table 32. Subsequently, the holding table 32 is arranged inside the accommodation chamber 111, so that the plurality of optical elements O are accommodated inside the accommodation chamber 111 (Step S1).

Subsequently, the heat insulating: cover 12 of the heating furnace 1 and the vacuum chamber door 42 are closed, and vacuuming is performed until the degree of vacuum reaches about 1 pascal (Pa) (Step S2). Subsequently, the gas supply source 21 supplies a nitrogen gas at a predetermined flow rate (for example, 50 liter per minute (L/min)) (Step S3), and replaces the nitrogen gas inside the accommodation chamber 111.

Subsequently, it is determined whether pressure inside the accommodation chamber 111 has reached atmospheric pressure on the basis of a measurement result of the Piranie gauge (not illustrated) (Step S4). If it is determined that the pressure inside the accommodation chamber 111 has reached the atmospheric pressure (Yes at Seep S4) , the flow rate of the nitrogen gas supplied by the gas supply source 21 is reduced from 50 L/min to 3 L/min for example (Step S5), and continues to supply the nitrogen gas at the reduced flow rate. Meanwhile, at Step S4, if it is determined that the pressure inside the accommodation chamber 111 has not reached the atmospheric pressure (No at Step S4), the process returns to Step S3.

Subsequently, it is determined whether oxygen concentration inside the accommodation chamber 111 has become equal to or smaller than a predetermined value (for example, equal to or smaller than 2 part per million (ppm)) on the basis of the measurement result of the oxygen meter 44 (Step S6). If it is determined that the oxygen concentration inside the accommodation chamber 111 has become equal to or smaller than the predetermined value (Yes at Step S6), the heater 112 is turned on (Step S7), and the annealing process is started (Step S8). In the annealing process, temperature of the spiral pipeline main body 221 is simultaneously increased, maintained, and decreased along with a temperature process of the heater 112. Meanwhile, at Step S6, if it is determined that the oxygen concentration inside the accommodation chamber 111 has not become equal to or smaller than the predetermined value (No at Step S6), the process returns to Step S5.

Subsequently, after the annealing process is terminated (Step S9), supply of the nitrogen gas from the gas supply source 21 is stopped, and the optical elements O are removed from the heating furnace 1 (Step S10).

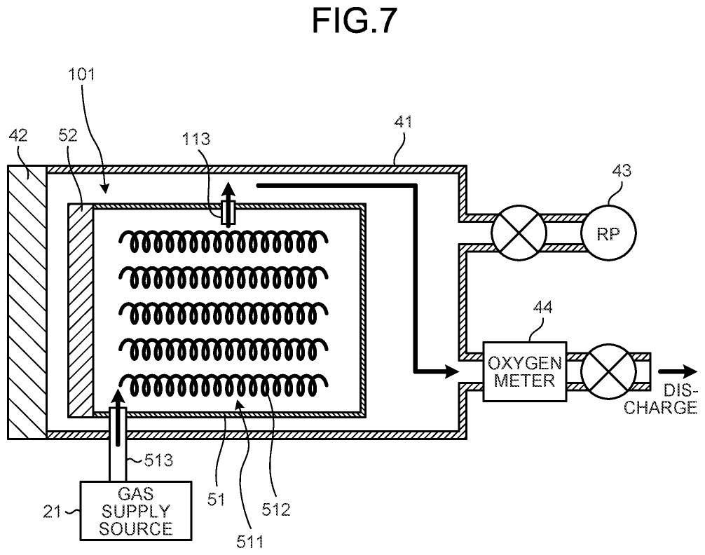

Here, in a conventional heating furnace 101, as illustrated in FIG. 7 for example, a heating furnace main body 51 is sealed by a heat insulating cover 52, a gas at ordinary temperature is supplied to the inside of an accommodation chamber 511 via a flow inlet 513, and the gas at ordinary temperature is heated by a heater 512. Therefore, in the conventional heating furnace 101, temperature in the furnace is not equalized, so that a temperature distribution varies inside the furnace, which is a problem.

In contrast, in the heating furnace 1 according to the present embodiment, at the time of the annealing process, the gas supplied to the inside of the pipeline main body 221 is gradually heated while passing through the pipeline main body 221, and is heated to the annealing point when being discharged from the discharge outlet 222. With this configuration, in the heating furnace 1, it is possible to supply the heated gas to the inside of the accommodation chamber 111. Therefore, according to the heating furnace 1, it is possible to reduce variation in the temperature distribution inside the furnace with a simple structure.

Furthermore, in the heating furnace 1, at the time of the annealing process, it is possible to heat the plurality of optical elements O housed in the palette 31 in a state in which variation in the temperature distribution does not occur (or is reduced). Therefore, it is possible to achieve the same quality in all of the optical elements O, so that it is possible to prevent variation in the quality.

### Second Embodiment

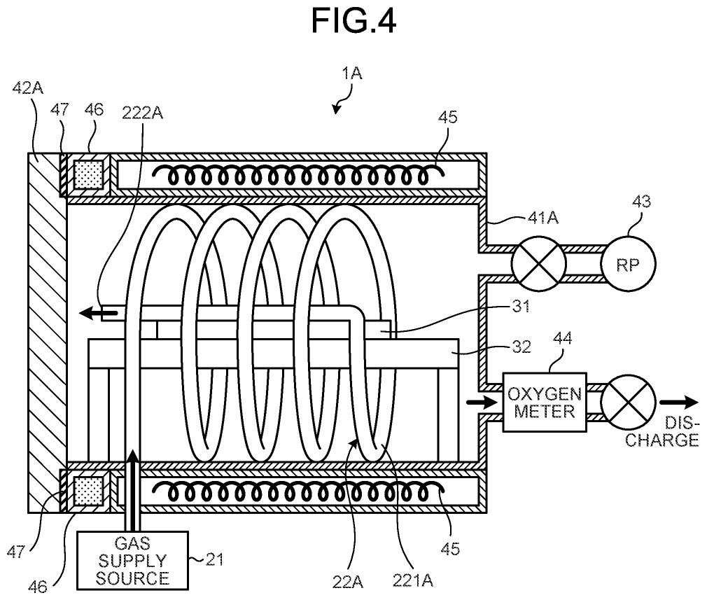

A heating furnace 1A according to a second embodiment of the present disclosure will be described below with reference to FIG. 4. The heating furnace 1A is a heating furnace of an external combustion system in which a heat source is arranged outside the furnace, and, as illustrated in FIG. 4, includes a vacuum chamber 41A, a vacuum chamber door 42A, the gas supply source 21, and a pipeline 22A.

The vacuum chamber 41A also functions as a heating furnace main body and is made of stainless steel. Heaters 45 as a pair are arranged around the vacuum chamber 41A. Packings 47 that are made of rubber and that are for ensuring sealing property are arranged between the vacuum chamber 41A and the vacuum chamber door 42A, which realizes a configuration in which the seal ng property is ensured by closing the vacuum chamber door 42A. Further, in the vacuum chamber 41A, cooling units 46 are arranged between the heaters 45 and the packings 47 to prevent degradation of the rubber packings 47 due to heat. The cooling units 46 are water-cooled cooling mechanisms to which cooling water is continuously supplied, for example.

In this manner, if the heating furnace 1A includes the cooling units 46, temperature on the vacuum chamber door 42A side is reduced at the time of the annealing process, and variation in the temperature distribution inside the furnace is likely to occur. To cope with this, in the heating furnace 1A, a discharge outlet 222A of the pipeline 22A is arranged so as to be oriented toward the vacuum chamber door 42A side on which the cooling units 46 are arranged. In other words, a pipeline main body 221A of the pipeline 22A has a certain shape that is wound from the vacuum chamber door 42A side to the rotary pump 43 side and then folded and extended to the vacuum chamber door 42A side through the inside of the spiral. With the pipeline 22A as described above, it is possible to reduce variation in the temperature distribution inside the furnace with a simple structure even in the heating furnace 1A of the external combustion system.

Furthermore, even in the heating furnace 1A, it is possible to heat the plurality of optical elements O housed in the palette 31 in a state in which variation in the temperature distribution does not occur (or is reduced) at the time of the annealing process, so that it is possible to prevent variation in the quality of the optical elements O.

### EXAMPLES

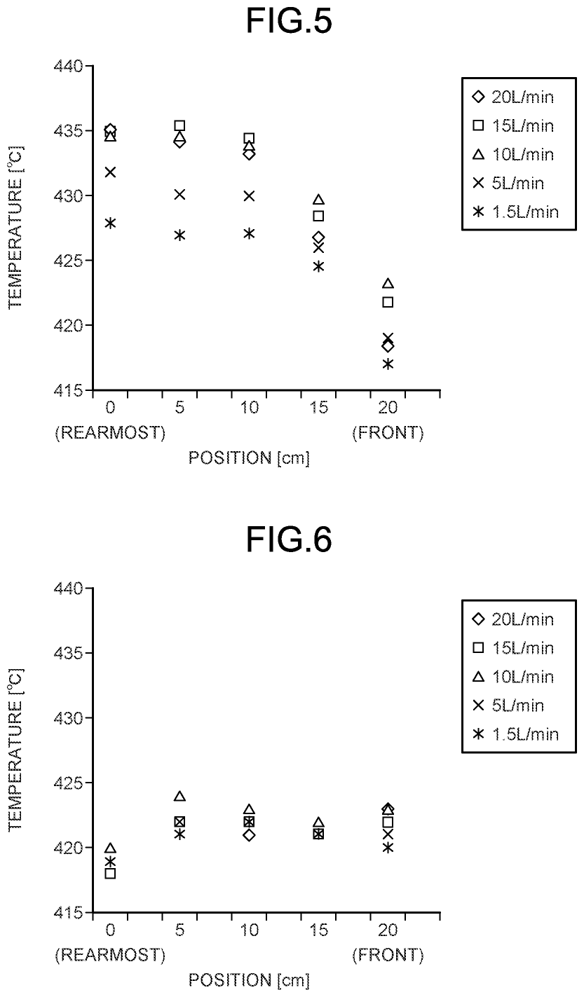

The present disclosure will be described in detail below using examples. FIG. 5 illustrates a temperature distribution in a case where a nitrogen gas at ordinary temperature and at a flow rate of 1.5 L/min to 20 L/min is supplied to the inside of the accommodation chamber an annealing process using the conventional heating furnace (see FIG. 7). As illustrated in FIG. 5, in the conventional heating furnace, variation in the temperature distribution between the rearmost side and the front side of the accommodation chamber occurs up to 17 degrees Celsius. Furthermore, in a case in which the flow rate of the nitrogen gas is high (for example, 15 L/min) and in a case in which the flow rate is low (1.5 L/min), variation in the temperature distribution tends to increase.

In contrast, FIG. 6 illustrates a temperature distribution in a case where a heated nitrogen gas at a flow rate of 1.5 L/min to 20 L/min is supplied to the inside of the accommodation chamber in an annealing process using the heating furnace according to the present disclosure (see FIG. 1). As illustrated in FIG. 6, in the heating furnace according to the present disclosure, variation in the temperature distribution between the rearmost side and the front side of the accommodation chamber occurs up to 5 degrees Celsius. Furthermore, even in a case in which the flow rate of the nitrogen gas is high (for example, 15 L/min) and in a case in which the flow rate is low (1.5 L/min), variation in the temperature distribution is small, e.g., about 1 degree Celsius to 3 degrees Celsius. In this manner, according to the heating furnace of the present disclosure, as compared to the conventional heating furnace, it is possible to largely reduce variation in the temperature distribution inside the furnace (inside the accommodation chamber).

Thus, the heating furnace according to the present disclosure is described in detail by using the embodiments and the examples of the present disclosure, but the contents of the present disclosure are not limited to the description above, and need to be broadly interpreted based on the description in the appended claims. Furthermore, various changes, modifications, and the like based on the description above are obviously included in the contents of the present disclosure.

For example, in the heating furnace 1 described above, the discharge outlet. 222 of the pipeline 22 is arranged so as to be oriented toward the rotary pump 43 side, but the discharge outlet 222 may be oriented to the opposite side, i.e., to the vacuum chamber door 42 side.

Furthermore, in each of the heating furnaces 1 and 1A, each of the pipeline main bodies 221 and 221A of the pipelines 22 and 22A is formed in a curved spiral shape, but the shapes of the pipelines 22 and 22A are not limited to this example. For example, the pipeline main bodies 221 and 221A of the pipelines 22 and 22A may be formed in linear spiral shapes with corner portions, or certain shapes obtained by folding a curve or a straight line.

According to the heating furnace of the present disclosure, at the time of an annealing process, a gas supplied to the inside of a pipeline is gradually heated while passing through a pipeline main body, and is heated to an annealing point when being discharged from a discharge outlet. With this configuration, in the heating furnace according to the present disclosure, it is possible to supply a heated gas to the inside of the accommodation chamber. Therefore, according to the heating furnace of the present disclosure, it is possible to reduce variation in a temperature distribution inside the furnace with a simple structure.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general concept as defined by the appended claims and their equivalents.

What is claimed is:

1. A heating furnace comprising:
a heating furnace main body that includes an accommodation chamber capable of accommodating a heating target object;
a heat source capable of heating an inside of the accommodation chamber to an annealing point that is set to perform an annealing process on the heating target object;
a gas supply source that is arranged outside the heating furnace main body; and
a pipeline that includes
a pipeline main body that is arranged inside the accommodation chamber, and that is heated by the heat source, the pipeline main body being configured to retain a gas supplied from the gas supply source and heat the gas to the annealing point, and
a discharge outlet that is formed on an end portion of the pipeline main body, and that is opened inside the accommodation chamber, the discharge outlet being configured to discharge the gas that is heated to the annealing point, to the inside of the accommodation chamber.

2. The heating furnace according to claim 1, wherein the pipeline main body is arranged in a region inside the accommodation chamber, the region facing the heat source.

3. The heating furnace according to claim 1, wherein
the pipeline main body is formed in a spiral manner, and
the heating target object is arranged inside the pipeline main body.

4. The heating furnace according to claim 1, wherein the discharge outlet is opened at an intermediate height position of the accommodation chamber.
